(19) United States
(12) Patent Application Publication
(10) Pub. No.: US 2014/0095280 A1
(43) Pub. Date: Apr. 3, 2014

(54) INFORMATION PROCESSING SYSTEM, COMPUTER-READABLE STORAGE MEDIUM HAVING STORED THEREIN PROGRAM, SERVER, INFORMATION PROCESSING APPARATUS, AND INFORMATION PROCESSING METHOD

(71) Applicant: NINTENDO CO., LTD., Kyoto (JP)

(72) Inventor: Yurie HATTORI, Kyoto (JP)

(73) Assignee: NINTENDO CO., LTD., Kyoto (JP)

(21) Appl. No.: 13/886,642

(22) Filed: May 3, 2013

(30) Foreign Application Priority Data
Sep. 28, 2012 (JP) 2012-216572

(51) Int. Cl. G06Q 30/02

(52) U.S. Cl. CPC G06Q 30/0209
USPC 705/14.12

(57) ABSTRACT

An example game system (100) includes full version game terminals (10A, 10B) and a limited version game terminal (10C), where the full version game terminals (10A, 10B) include a function of creating coordinated pieces (10AC, 10BC) based on instructions from users, a function of uploading data of the created coordinated pieces (10AC, 10BC) to a piece exhibition server (20), and a function of viewing coordinated pieces (211, 221) whose data have been uploaded by other full version game terminals, and where the limited version game terminal (10C) includes a function of creating a piece (10CC) based on an instruction from a user, and a function of viewing pieces (211, 221) whose data have been uploaded by the full version game terminals (10A, 10B), but does not include a function of uploading the created piece (10CC).

### BACKGROUND

1. Field

The technology herein relates to an information processing system for obtaining predetermined data according to an operation of a user, a computer-readable storage medium having stored therein a program for the information processing system, an information processing apparatus, an information processing method, and a server for viewing the obtained data.

2. Description of the Related Art

Conventionally, a game provider sometimes provides, at the time of providing a game to users, a trial version of the game in addition to a commercial version of the game.

The purpose of preparing a trial version of a game is, for example, in a case of providing a commercial version of the game for a fee, to promote purchase of the commercial version by preparing a free trial version and letting a number of users use it, or to encourage users to play the game by making a system where users play the trial version to a certain degree and then upgrade to the commercial version.

However, if a trial version of a game is prepared, there is a problem that users become content with the trial version of the game, and the effect of encouraging transition to a commercial version is not significant.

### SUMMARY

This application describes a system for encouraging version transition.

An information processing system according to an example embodiment is an information processing system including an information processing apparatus for performing information processing according to a first program, and an information processing apparatus for performing information processing according to a second program different from the first program. The information processing apparatus for performing information processing according to the first program includes a first acquisition section for obtaining predetermined data according to an operation of a user, an upload section for uploading the data acquired by the first acquisition section, and a first viewing section for viewing the data uploaded by another information processing apparatus for performing information processing according to the first program. The information processing apparatus for performing information processing according to the second program includes a second acquisition section for obtaining predetermined data according to an operation of a user, and a second viewing section for viewing the data uploaded by the information processing apparatus for performing information processing according to the first program, but does not include a section for uploading the data acquired by the second acquisition section.

According to this configuration, the information processing apparatus for performing information processing according to the second program does not include a section for uploading acquired data and is partially limited with respect to the functions of the information processing, but is capable of viewing data uploaded by another information processing apparatus for performing information processing according to the first program, and accordingly, the appeal of the information processing according to the first program may be conveyed to a user of the information processing apparatus for performing information processing according to the second program, and transition from the second program to the first program may thus be encouraged. The information processing apparatus for performing information processing according to the first program and the information processing apparatus for performing information processing according to the second program are different at least in that the information processing apparatus for performing information processing according to the first program includes a section for uploading acquired data.

The first program and the second program may be different in their functions.

According to this configuration, different functions may be achieved by the information processing apparatus for performing information processing according to the first program and the information processing apparatus for performing information processing according to the second program.

Functions of the first program may be partially limited for the second program.

According to this configuration, the functions of the information processing apparatus for performing information processing according to the first program may be partially limited for the information processing apparatus for performing information processing according to the second program.

The first acquisition section and the second acquisition section may each create a piece as the data, according to an instruction from a user.

According to this configuration, a piece created by a user of the first program may be exhibited, and a user of the second program may view the piece created by the user of the first program, and thus, the appeal of a piece creating game may be conveyed to the user of the second program.

The first acquisition section and the second acquisition section may each create the piece using a possessed item.

According to this configuration, the piece may be easily created using an item.

The first acquisition section and the second acquisition section may each create, as the piece, a piece by combining a plurality of items.

According to this configuration, the piece may be easily created by combining a plurality of items.

The item may be possessed by purchasing using virtual money.

According to this configuration, a user will acquire an item after a more careful consideration, and the entertaining property of the game is increased.

In a case where an information processing apparatus that was performing information processing according to the second program is to perform information processing according to the first program, the data that was possessed when information processing was being performed according to the second program may be inherited as possessed data when performing information processing according to the first program.

According to this configuration, in the case of transitioning from the second program to the first program, the data that was possessed when in the second program may be carried over to the first program, and a user of the second program who has vigorously acquired data in the second program is not negatively affected by the transition to the first program, that is, there is no data loss due to the transition, and thus, transition from the second program to the first program may be encouraged.

The second program may be executed by the information processing apparatus as a trial version game for encouraging transition to the first program.

According to this configuration, transition to the first program may be encouraged by having a new user experience the second program.

The information processing apparatus for performing information processing according to the first program and the information processing apparatus for performing information processing according to the second program may each further include an action section for performing an action with respect to a desired piece whose data has been uploaded, and the action may be fed back to an uploader of the piece.

According to this configuration, a user of the second program may also perform an action with respect to another user's piece, and the user may imagine the enjoyment he/she can experience when he/she has become a user of the first program.

The action may be rating of the piece whose data has been uploaded, and the rating may be fed back to the uploader of the piece.

According to this configuration, a user of the second program is motivated to become a user of the first program and to receive reactions from other users with respect to his/her piece, and thus, transition from the second program to the first program may be encouraged.

The action may be downloading of the piece whose data has been uploaded, and the downloading may be fed back to the uploader of the piece.

Also according to this configuration, a user of the second program is motivated to become a user of the first program and to receive reactions from other users with respect to his/her piece, and transition from the second program to the first program may be encouraged.

The piece may be purchased using virtual money, and when the piece is purchased, a remaining amount of the virtual money of a user who has uploaded the piece may be increased.

According to this configuration, a user will acquire an item after a more careful consideration, and the entertaining property of the game is increased, and also, since a user of the first program may increase the remaining amount of virtual money by uploading of a piece, which is allowed only to a user of the first program, transition from the second program to the first program may be encouraged.

The upload section may upload data of the piece to a server, and the first viewing section and the second viewing section may each view the piece uploaded to the server.

According to this configuration, other users may view the data uploaded to the server, and thus, the entertaining property of the game is increased.

The data of the piece may be exhibited in a virtual space provided by the server, by being uploaded to the server.

According to this configuration, a piece exhibition screen in the manner of a shopping mall where pieces are being sold in the virtual space may be displayed at an information processing apparatus, and the entertaining property of the game is increased.

A computer-readable storage medium of an example embodiment is a computer-readable storage medium having stored therein a second program causing a computer of an information processing apparatus to function as: a second acquisition section for obtaining predetermined data according to an operation of a user, and a second viewing section for viewing the data uploaded by an information processing apparatus for performing information processing according to a first program different from the second program, where the second program does not cause the computer to function as a section for uploading the data obtained by the second acquisition section.

According to this configuration, the information processing apparatus does not include a section for uploading acquired data and is partially limited with respect to the functions of the information processing, but is capable of viewing data uploaded by another information processing apparatus for performing information processing according to a first program different from the second program, and accordingly, the appeal of the information processing according to the first program may be conveyed to a user of the second program, and transition from the second program to the first program may thus be encouraged.

A computer-readable storage medium of an example embodiment is a computer-readable storage medium having stored therein a first program causing a computer of an information processing apparatus to function as: a first acquisition section for acquiring predetermined data according to an operation of a user, an upload section for uploading the data acquired by the first acquisition section, a first viewing section for viewing data uploaded by another information processing apparatus, and a data inheritance section for inheriting, as data to be possessed when performing information processing according to the first program, data possessed when information processing was being performed according to a second program that causes a computer to function as a second acquisition section for acquiring predetermined data but not as a section for uploading the acquired data.

According to this configuration, in the case of transitioning from the second program to the first program, the data acquired by the second program may be carried over to the first program, and a user who has vigorously played in the second program is not negatively affected by the transition to the first program, that is, there is no data loss due to the transition, and thus, transition from the second program to the first program may be encouraged.

A server of an example embodiment is a server for configuring an information processing system by being connected, in a manner capable of communication, to an information processing apparatus for performing information processing according to a first program and an information processing apparatus for performing information processing according to a second program different from the first program, the server including a viewing screen generation section for generating a viewing screen for allowing viewing of data uploaded by the information processing apparatus for performing information processing according to the first program, and a transmission section for transmitting the viewing screen in response to a viewing request from the information processing apparatus for performing information processing according to the first program or from the information processing apparatus for performing information processing according to the second program, where the viewing screen does not include data acquired by the information processing apparatus for performing information processing according to the second program.

According to this configuration, the viewing screen does not include data obtained by the second program, but includes data uploaded by the first program, and the second program is partially limited with respect to the functions of the information processing, and the appeal of the information processing by the first program may be conveyed to the user of the second program, and transition from the second program to the first program may be encouraged.

An information processing apparatus of an example embodiment is an information processing apparatus for performing information processing according to a second program, the information processing apparatus including a second acquisition section for obtaining predetermined data according to an operation of a user, and a second viewing section for viewing the data uploaded by an information processing apparatus for performing information processing according to a first program different from the second program, where the information processing apparatus for performing information processing according to the second program does not include a section for uploading the data acquired by the second acquisition section.

According to this configuration, a section for uploading obtained data is not included and the functions of information processing are partially limited while viewing of data uploaded by another information processing apparatus for performing information processing according to a first program different from the second program is allowed, and the appeal of the information processing according to the first program may be conveyed to a user of the second program, and transition from the second program to the first program may thus be encouraged.

An information processing method of an example embodiment is an information processing method comprising: acquiring predetermined data according to an operation of a user, by an information processing apparatus for performing information processing according to a first program, uploading the acquired data by the information processing apparatus for performing information processing according to the first program, viewing, by the information processing apparatus for performing information processing according to the first program, the data uploaded by another information processing apparatus for performing information processing according to the first program, acquiring predetermined data according to an operation of a user, by an information processing apparatus for performing information processing according to a second program different from the first program, and viewing, by the information processing apparatus for performing information processing according to the second program, the data uploaded by the information processing apparatus for performing information processing according to the first program, where the information processing apparatus for performing information processing according to the second program does not upload the data.

Also according to this configuration, the information processing apparatus for performing information processing according to the second program does not include a section for uploading acquired data and is partially limited with respect to the functions of the information processing, but is capable of viewing data uploaded by another information processing apparatus for performing information processing according to the first program, and accordingly, the appeal of the information processing according to the first program may be conveyed to a user of the information processing apparatus for performing information processing according to the second program, and transition from the second program to the first program may be encouraged.

These and other object, features, aspects and advantages of the technology will become more apparent from the following detailed description of non-limiting example embodiments when taken in conjunction with the accompanying drawings.

### BRIEF DESCRIPTION OF THE DRAWINGS

FIG. 1 shows an example non-limiting schematic diagram for describing a coordinating game of a game system;

FIG. 2 shows an example non-limiting table of differences between the functions of a full version and a limited version;

FIG. 3 shows an example non-limiting block diagram showing a configuration of the game system;

FIG. 4A shows a non-limiting example of data of possessed items stored in a storage section of a game terminal;

FIG. 4B shows a non-limiting example of data of possessed items stored in the storage section of the game terminal;

FIG. 4C shows a non-limiting example of data of possessed items stored in the storage section of the game terminal;

FIG. 5A shows a non-limiting example of data of coordinated pieces stored in the storage section of the game terminal;

FIG. 5B shows a non-limiting example of data of coordinated pieces stored in the storage section of the game terminal;

FIG. 5C shows a non-limiting example of data of coordinated pieces stored in the storage section of the game terminal; and

FIG. 6 shows a non-limiting example of data of coordinated pieces stored in a storage section of an exhibition server.

### DETAILED DESCRIPTION OF THE PREFERRED EMBODIMENTS

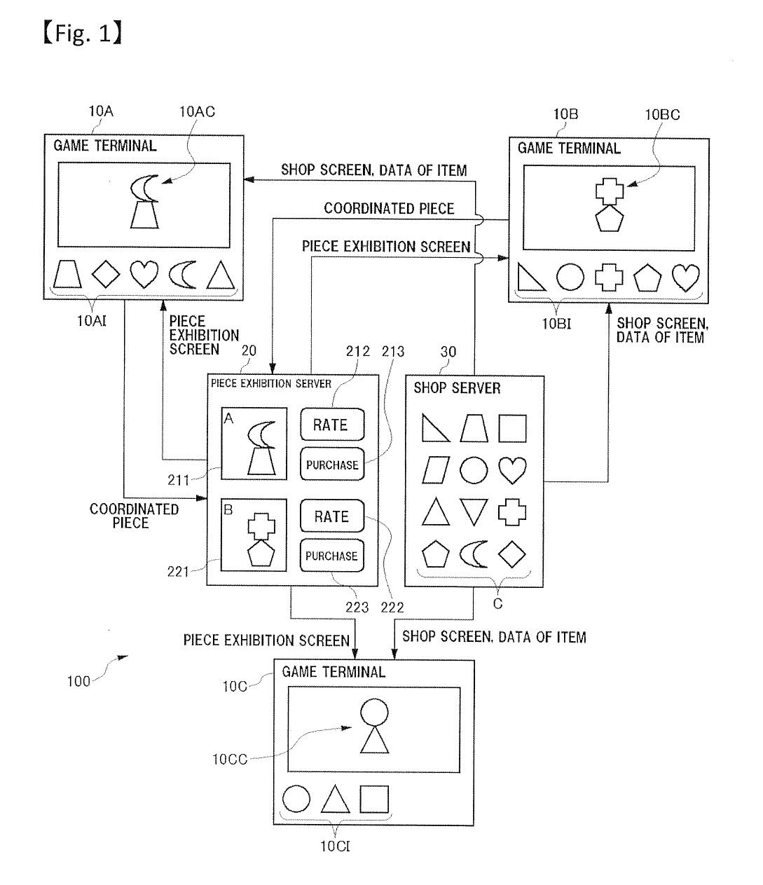

Hereinafter, non-limiting example embodiments will be described with reference to the drawings. In the following, a case where an information processing system is a game system will be described as an example, but information processing performed at each terminal (an information processing apparatus) of the information processing system is not limited to games. FIG. 1 is an example non-limiting schematic diagram for describing a game of a game system. A game system 100 includes a plurality of game terminals 10A, 10B, and 10C (hereinafter, referred collectively to as “game terminal(s) 10”), a piece exhibition server 20, and a shop server 30. The game terminals 10 may each connect to the piece exhibition server 20 and the shop server 30 over a network to perform mutual communication.

The game system 100 provides a data acquisition game of creating a piece using items based on a user instruction. In the data acquisition game of the present embodiment, items are clothing, and a user creates a piece by combining clothes. That is, the piece according to the present embodiment is a coordinate of clothes (hereinafter, referred to as a “coordinated piece”), and the data acquisition game according to the present embodiment is a coordinating game. Here, a “piece” to be created may also be called a UGC (User-Generated Content) or a product. In the coordinating game, shoes, hats, accessories and the like may be included as the items, in addition to clothing, but in the present specification, an example where only clothes for upper body (top item) and clothes for lower body (bottom item) are included as the items is described for the sake of simplicity of description. Moreover, in FIGS. 1, and 4 to 6, each item is expressed by a circle, a triangle or the like for the sake of convenience.

The coordinating game is performed by the game terminal 10, and a user may play the coordinating game with the game terminal 10. Before describing the contents of the coordinating game, a full version and a limited version of the coordinating game will be described. In a full version of the coordinating game, all the functions of the coordinating game may be used, and in a limited version of the coordinating game, use of a part of the functions of the coordinating game is limited. In the limited version of the coordinating game, further limitation may be imposed on the number of times of playing or the playing duration.

First, the full version of the coordinating game will be described. In the example of FIG. 1, the game terminals 10A and 10B are allowed to perform the full version of the coordinating game. A user of the game terminal 10 that performs the full version of the coordinating game (the user and the game terminal 10 will be hereinafter referred to as “full version user” and “full version game terminal 10”, respectively) may purchase any item from a large number of items C provided by the shop server 30. To purchase an item, virtual money given to the user is used. A certain amount of virtual money is given to the full version user at the time of start of the game. Here, the program of the full version of the coordinating game is referred to also as a first program.

The user may perform coordination, with the game terminal 10, using possessed items, or more specifically, by combining any of the clothes for upper body and the clothes for lower body that the user possesses. An example coordinate AC that a user A has created by combining items 10AI that the user A possesses is shown on the game terminal 10A in FIG. 1, and an example coordinate 10BC that a user B has created by combining items 10BI that the user B possesses is shown on the game terminal 10B in FIG. 1.

The full version user may upload data of a coordinated piece, which is a combination of clothes for upper body and clothes for lower body, from the full version game terminal 10 to the piece exhibition server 20. Additionally, the full version user may upload up to three coordinated pieces to the piece exhibition server 20.

The piece exhibition server 20 generates a piece exhibition screen for allowing other users to view the coordinated pieces whose data have been uploaded from the full version game terminal 10. The piece exhibition screen displays a virtual space, and a shop is set up in this virtual space for each user in the manner of a shopping mall where a coordinated piece whose data has been uploaded by a user is exhibited and sold at the shop of the user. This piece exhibition screen is referred to also as a viewing screen.

The full version user may access the piece exhibition server 20 from the full version game terminal 10, and view all the coordinated pieces whose data have been uploaded to the piece exhibition server 20. At this time, as shown in FIG. 1, the piece exhibition screen provided to the full version game terminal 10 by the piece exhibition server 20 includes, together with coordinated pieces 211 and 221, buttons to be used by a viewing user for performing an action with respect to the coordinated pieces, such as “rate” buttons 212 and 222 for the viewing user to give high ratings on the coordinated pieces, and “purchase” buttons 213 and 223 for the viewing user to purchase the coordinated pieces, for example. Additionally, the method of rating a coordinated piece of another user may be other than the method of pressing a button, such as a method of selecting from a scale of 1 to 5, a method of inputting a comment, or the like.

The full version user may display the piece exhibition screen on the full version game terminal 10, and may, while viewing the coordinated pieces of other users, give a high rating on a coordinated piece by pressing the “rate” button 211 or 221 if he/she wants to give a high rating on the coordinated piece, and may purchase a coordinated piece by pressing the “purchase” button 213 or 223 if there is a coordinated piece that he/she wants to purchase. The virtual money given to the user is used at the time of purchase of the coordinated piece. When the coordinated piece is purchased, items included therein (the clothes for upper body and the clothes for lower body) are added to the items possessed by the user who has made the purchase.

On the other hand, when a coordinated piece is purchased by a user, the result is fed back or reflected for a user who has uploaded the data of the coordinated piece on the piece exhibition server 20. For example, the amount of payment received is added to the virtual money possessed by the selling user. That is, the sales of one's coordinated piece at the piece exhibition server 20 are reflected in the virtual money of the user. Here, an amount obtained by multiplying the amount of payment for a coordinated piece by a certain factor may be added to the remaining amount of one's virtual money instead of the amount of payment being added as it is to the remaining amount of one's virtual money.

Next, the limited version of the coordinating game will be described. In the example of FIG. 1, the game terminal 10C is allowed to perform the limited version of the coordinating game. A user of the game terminal 10 that performs the limited version of the coordinating game (the user and the game terminal 10 will be hereinafter referred to as “limited version user” and “limited version game terminal 10”, respectively) may also purchase any item from a large number of items C provided by the shop server 30. To purchase an item, virtual money given to the limited version user is used. A certain amount of virtual money is given to the limited version user at the time of start of the game. Here, the program of the limited version of the coordinating game is referred to also as a second program.

Like the full version user, the limited version user may perform coordination, with the limited version game terminal 10, by combining any of the clothes for upper body and the clothes for lower body that the user possesses. An example of a coordinated piece 10CC created by combining items 10CI possessed by a user C is shown on the game terminal 10C in FIG. 1.

Also, like the full version user, the limited version user may access the piece exhibition server 20 from the limited version game terminal 10, and view all the coordinated pieces whose data have been uploaded on the piece exhibition server 20 by other users.

Furthermore, the limited version user may display the piece exhibition screen on the limited version game terminal 10, and may, while viewing coordinated pieces of other users, give a high rating on a coordinated piece by pressing the “rate” button 212 or 222 if he/she wants to give a high rating on the coordinated piece, and may purchase a coordinated piece by pressing the “purchase” button 213 or 223 if there is a coordinated piece that he/she wants to purchase. The virtual money given to the limited version user is used at the time of purchase of the clothing. When a coordinated piece is purchased, items included therein (the clothes for upper body and the clothes for lower body) are added to the items possessed by the user who has made the purchase.

The limited version user may not upload a coordinated piece to the piece exhibition server 20. That is, the function of uploading a coordinated piece to the piece exhibition server 20 is limited for the limited version game terminal 10. Moreover, besides this limitation, purchase of items from the shop server 30 described above may be limited for the limited version user (that is, an item may be acquired only by purchasing a coordinated piece of another user). In this case, several items may be given to the limited version user in advance so that coordination described above may be performed.

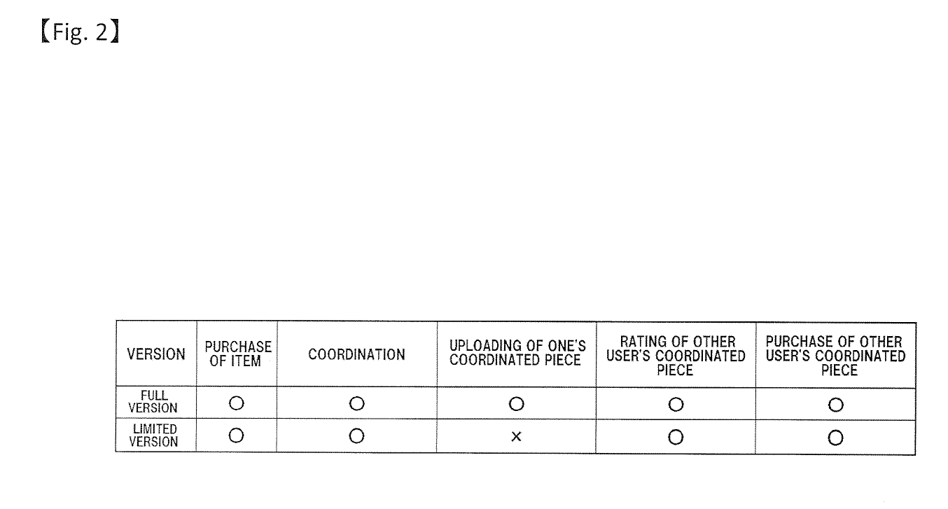

FIG. 2 is a table of differences between the functions of the full version and the limited version. As shown in FIG. 2, purchase of an item, coordination of possessed items, and rating and purchase of another user's coordinated piece whose data is uploaded to the piece exhibition server 20 are allowed in both the full version and the limited version. The function limited by the system for the limited version user is the function of uploading a coordinated piece.

Moreover, in contrast to the full version user who can increase the amount of virtual money by the sales of his/her coordinated pieces, the limited version user is restricted from using the upload function and is not able to sell coordinated pieces, and thus he/she is not able to increase the amount of virtual money by selling. Accordingly, the items that the limited version user can purchase from the shop server 30 or the coordinated pieces that he/she can purchase from the piece exhibition server 20 are limited to the amount of virtual money given in the beginning. In this respect, the limited version user is limited also with respect to the items or the coordinated pieces that he/she can purchase.

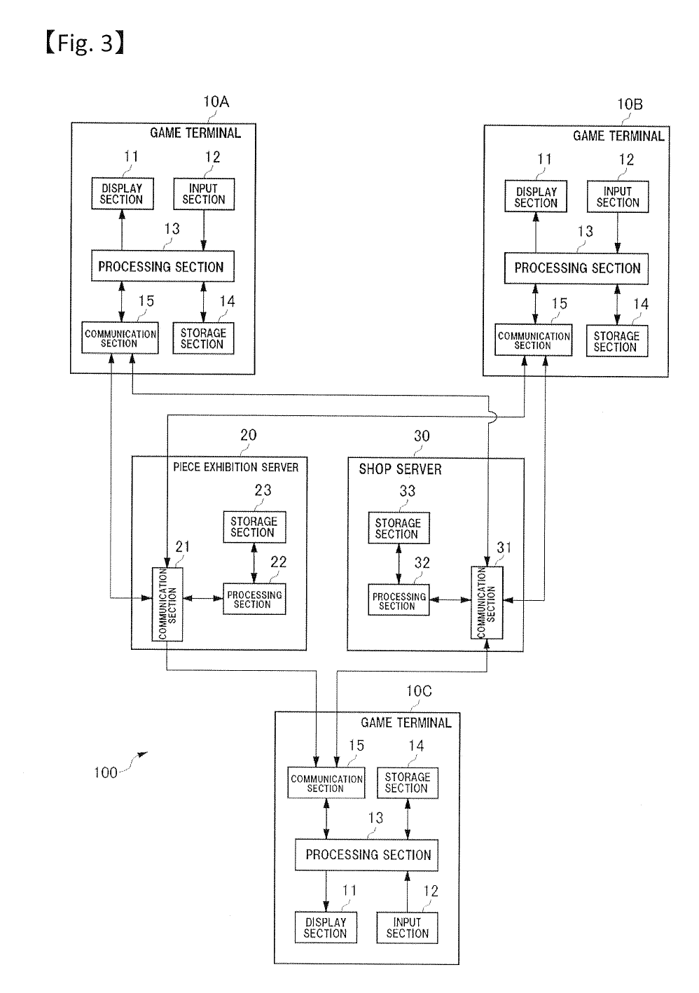

Heretofore, an overview of the coordinating game of the present embodiment has been described. In the following, a configuration of the game system 100 for realizing the coordinating game described above will be described. FIG. 3 is a block diagram showing a configuration of the game system 100, and is in accordance with FIG. 1. As described above, the game system 100 includes a plurality of game terminals 10, the piece exhibition server 20, and the shop server 30. In the example in FIG. 3, three game terminals 10A, 10B, and 10C are shown. The game terminals 10A and 10B are the full version game terminals, and the game terminal 10C is the limited version game terminal.

The hardware configurations of the game terminals 10A, 10B, and the 10C are the same, and the game terminals each include a display section 11, an input section 12, a processing section 13, a storage section 14, and a communication section 15. The display section 11 is a liquid crystal panel. The input section 12 is formed from a touch sensor provided overlapping the display section 11 (the liquid crystal panel), and various mechanical buttons provided to the game terminal 10.

The processing section 13 performs game processing and other basic information processing of the game terminal 10 by executing a game program for performing the coordinating game and basic programs for realizing the basic functions of the game terminal 10. The communication section 15 connects to, and performs data communication with, the piece exhibition server 20 and the shop server 30 over a network including a wireless public line. The communication section 15 connects to the network by wireless communication.

The storage section 14 stores the basic programs and the game program. The storage section 14 further stores data generated by the coordinating game. The storage section 14 may be formed from a built-in memory that is embedded in the game terminal 10A, and a portable memory that may be attached or removed to or from the game terminal 10A. In this case, the game program for the full version and the data created by the coordinating game in the full version may be stored in the portable memory which is a computer-readable storage medium. Also, the game program for the limited version and the data created by the coordinating game in the limited version may be stored in the built-in memory. Data of possessed items and data of the coordinated pieces are stored in the storage section 14 as data created by the coordinating game.

Furthermore, the game terminal 10 may download the game program from a server providing the game program, via a network. Additionally, the game program for the full version is stored in the storage sections 14 of the game terminals 10A and 10B, and the game program for the limited version is stored in the storage section 14 of the game terminal 10C, but especially the game program for the limited version may be stored in the storage section 14 by being downloaded.

The piece exhibition server 20 includes a communication section 21, a processing section 22, and a storage section 23. The communication section 21 connects to the game terminal 10 over a network including a wireless public line, and performs data communication with the game terminal 10. The processing section 22 performs various types of information processing, such as generation of the piece exhibition screen, a rating process, a purchasing process, and the like. The storage section 23 stores data of the coordinated piece uploaded from the game terminal 10.

The shop server 30 also includes a communication section 31, a processing section 32, and a storage section 33. The communication section 31 connects to the game terminal 10 over a network including a wireless public line, and performs data communication with the game terminal 10. The processing section 32 performs various types of information processing, such as generation of a shop screen, a purchasing process, and the like. Additionally, the piece exhibition server 20 and the shop server 30 may be realized by one server computer. The storage section 33 stores data of items to be sold to users.

Next, the operation of the game system 100, and data stored in each storage section will be described. In both the full version and the limited version, a user is given a certain amount of virtual money at the time of starting the coordinating game. Using this virtual money, the user accesses the shop server 30 and purchases an item, or accesses the piece exhibition server 20 and purchases a coordinated piece of another user.

### Purchase of Item

The remaining amount of virtual money, information of a possessed item, and a user ID are stored in the storage sections 14 of the game terminals 10A, 103, and 10C. Specifically, data of all the items are stored in the storage section 14 of the game terminal 10 and a flag indicating possession by the user is added to the data of each item, and when an item is purchased, the processing section 13 sets the flag of the item (the flag is set from 0 to 1). If an item whose data is not in the game terminal 10 (for example, a new item) is sold at the shop server 30, and the item is purchased by the game terminal 10, the game terminal 10 downloads the data of the item from the shop server 30, sets the flag, and stores the data of the item in the storage section 14 as a possessed item.

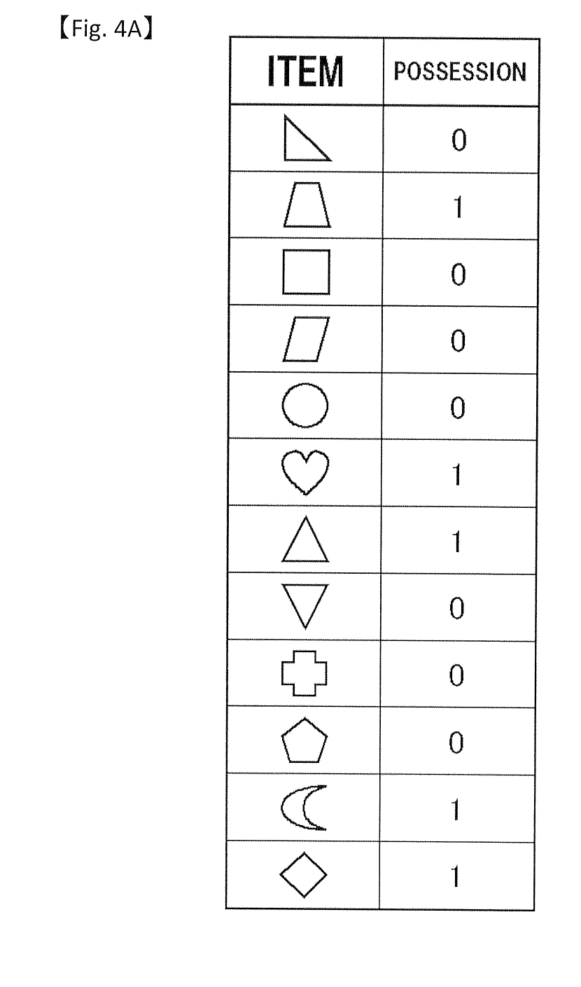

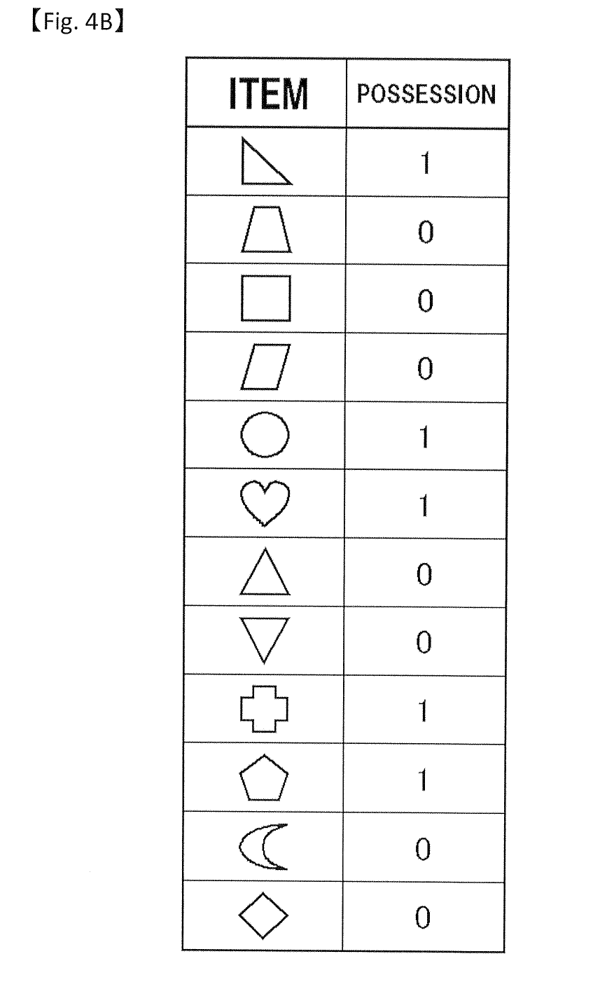

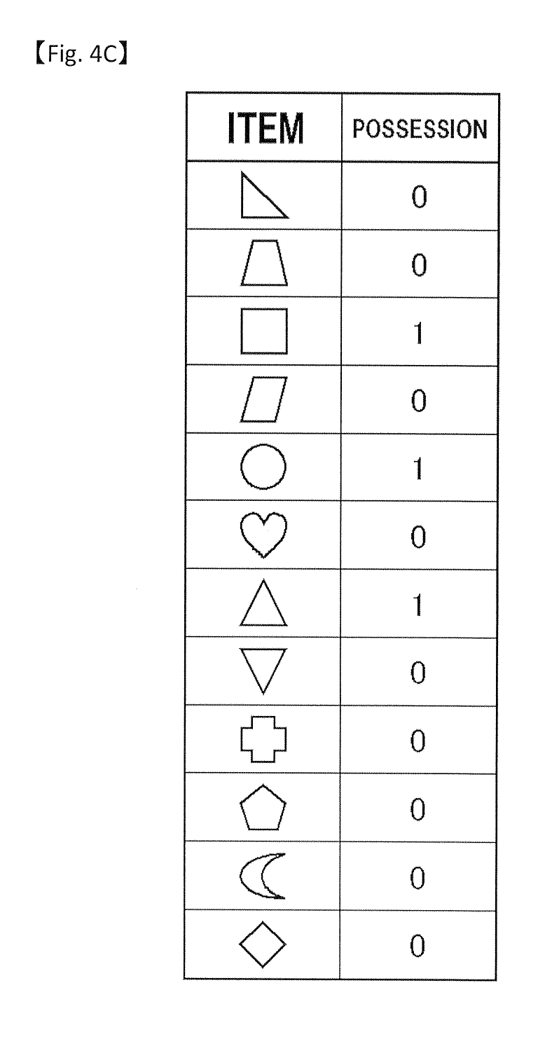

FIGS. 4A to 4C are diagrams showing examples of the data of items stored in the storage sections 14 of the game terminals 10A to 10C. Additionally, data of an item includes an item ID, attribute for coordination (that is, information indicating whether the item is a top item or a bottom item), the price of the item, and an image of the item. As shown in FIGS. 4A to 4C, the data of items are stored in the storage section 14 of the game terminal 10, and flags indicating possession/non-possession (purchased or not purchased) are added to these pieces of data. Additionally, the examples in FIGS. 4A to 4C are in accordance with FIG. 1.

The processing section 13 accesses the shop server 30 via the communication section 15, and performs a purchasing process for an item provided by the shop server 30. In the purchasing process, first, the game terminal 10 receives a shop screen from the shop server 30, and displays the same on the display section 11. A user selects an item to purchase using the shop screen.

If the selected item is stored in the storage section 14, the processing section 13 sets a purchased flag for the item. If the selected item is not stored in the storage section 14, the processing section 13 downloads data of the item from the shop server 30 via the communication section 15, sets the purchased flag, and adds the item to a list of possessed items in the storage section 14.

Together with these processes, the processing section 13 updates the remaining amount of virtual money by subtracting the price of the purchased item from the remaining amount of virtual money stored in the storage section 14. Additionally, in the instance of the remaining amount becoming negative, the processing section 13 does not perform the purchasing process for the item, and displays, using the display section 11, a message to the user to the effect that purchase is not possible due to lack of money.

### Coordination

A user may create, using the game terminal 10, a coordinated piece by combining items that the user possesses. The processing section 13 generates, according to operation information input from the input section 12, data of the coordinated piece by combining items among the possessed items according to the attributes, and stores the data in the storage section 14. The function of the processing section 13 of creating a coordinated piece based on an instruction from a user in this manner is referred to also as a first acquisition section or a second acquisition section.

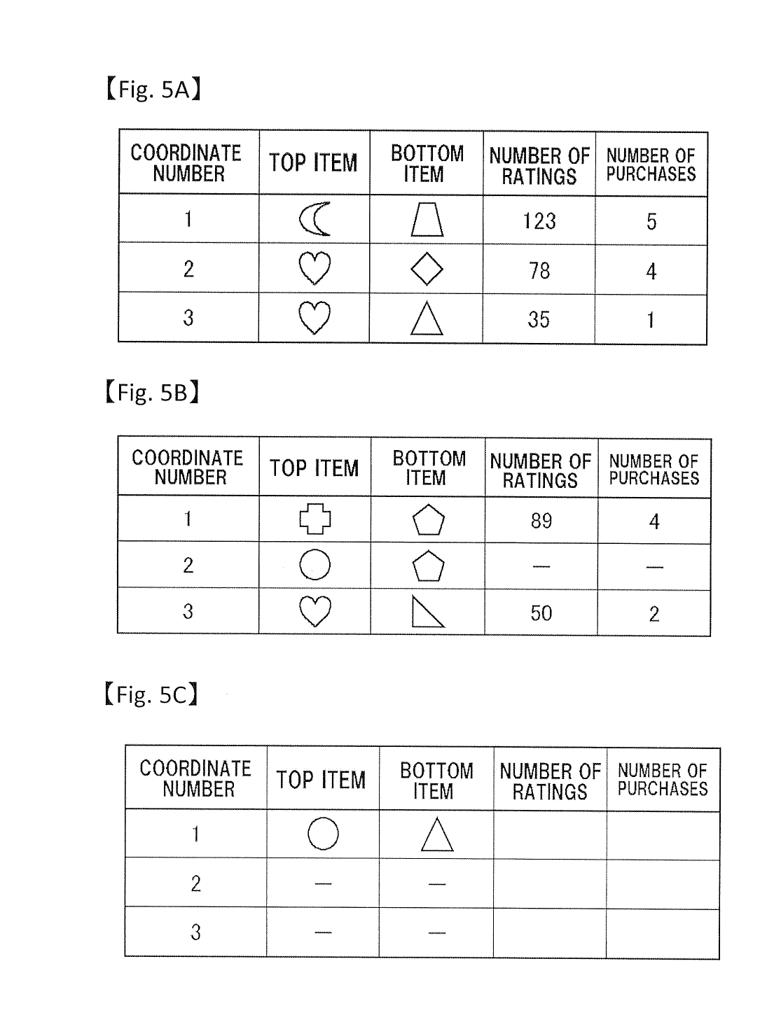

FIGS. 5A to 5C are diagrams showing examples of the data of coordinated pieces stored in the storage sections 14 of the game terminals 10A to 10C. The data of each coordinated piece includes information of a coordinate number, a coordinated top item, a coordinated bottom item, the number of ratings, and the number of purchases. Additionally, in FIGS. 5A to 5C, top items and bottom items are both expressed by figures, but in reality, item IDs of corresponding items are stored. That is, the storage section 14 of the game terminal 10 stores the data of a coordinated piece as a combination of item IDs. The number of ratings and the number of purchases will be described later.

### Upload of Coordinated Piece

As described above, the game terminals 10A and 10B in the full version is capable of uploading data of created coordinated pieces to the piece exhibition server 20. The processing sections 13 of the game terminals 10A and 10B in the full version upload data of coordinated pieces specified among created coordinated pieces to the piece exhibition server 20 via the communication sections 15 according to operation information input from the input sections 12. Data of coordinated pieces are transmitted from the communication sections 15 to the piece exhibition server 20 together with user IDs. The function of the processing section 13 and the communication section 15 of transmitting data of a coordinated piece to the piece exhibition server 20 in this manner is referred to also as an upload section.

The function of uploading is limited for the game terminal 10C in the limited version. Due to this limitation, the upload function is not included in the game program of the limited version. Additionally, the upload function may be included in the game program of the limited version, and a function of placing a limit on the upload function may be further provided. Here, the presence of the upload function, and that the use of the upload function is limited may be displayed at the game terminal 100 in the limited version.

Alternatively, whether to allow upload of a coordinated piece or not may be decided not by distinguishing between the limited version and the full version of the game program, but by making the user IDs different for the full version and the limited version and checking the user ID transmitted together with the data of a coordinated piece at the processing section 22 of the piece exhibition server 20. Or, an identifier indicating whether a user is a full version user or a limited version user may be transmitted to the piece exhibition server 20 together with the data of a coordinated piece and the user ID, and the processing section 22 of the piece exhibition server 20 may determine, based on the identifier, whether the coordinated piece may be uploaded or not. If upload is rejected at this time, that the upload function is limited may be displayed at the game terminal.

### Exhibition, Rating, and Purchase of Coordinated Piece

When the piece exhibition server 20 receives data of a coordinated piece from the game terminal 10 in the full version, the piece exhibition server 20 stores the data in the storage section 23. The processing section 22 generates a piece exhibition screen for exhibiting coordinated pieces, using data of a coordinated piece from each game terminal 10 stored in the storage section 23. Since the piece exhibition server 20 receives upload of coordinated pieces from full version game terminals 10, this piece exhibition screen includes only the coordinated pieces created by the full version users, and not the coordinated pieces created by the limited version users. The function of the processing section 22 of generating the piece exhibition screen is referred to also as an exhibition screen generation section.

To view the piece exhibition screen at the game terminal 10, a viewing request for the piece exhibition screen is transmitted to the piece exhibition server 20 from the communication section 15 of the game terminal 10. When the viewing request is received from the game terminal 10, the processing section 22 transmits the generated piece exhibition screen from the communication section 21 to the game terminal 10. The function of the processing section 22 and the communication section 21 is referred to also as a transmission section. At the game terminal 10, the piece exhibition screen is received by the communication section 15, and the processing section 13 displays the piece exhibition screen at the display section 11. The function of the communication section 15, the processing section 13, and the display section 11 are referred to also as a first viewing section and a second viewing section.

As described above, a “rate” button and a “purchase” button are provided on the piece exhibition screen for each coordinated piece. When the “rate” button is specified by the input section 12 at the game terminal 10 which has received the piece exhibition screen and which is displaying the screen on the display section 11, the processing section 13 transmits, according to the specification, rating instruction information to the piece exhibition server 20 via the communication section 15. The function of the display section 11, the input section 12, the processing section 13, and the communication section 15 is referred to also as an action section.

When the “purchase” button is specified by the input section 12, the processing section 13 of the game terminal 10 compares, according to the specification, the price of the corresponding coordinated piece and the remaining amount of the virtual money of the user, and if the remaining amount is larger, the processing section 13 transmits purchasing instruction information to the piece exhibition server 20 via the communication section 15, and sets flags stored in the storage section 14 for the items included in the coordinated piece. The user may thereby possess the items included in the purchased coordinated piece as his/her own items.

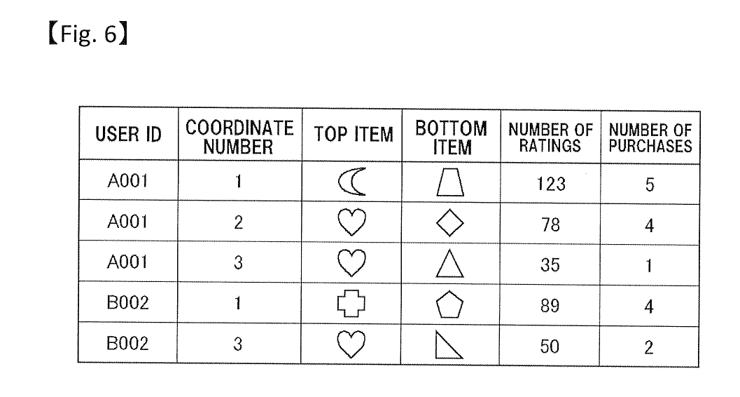

FIG. 6 is a diagram showing an example of the data of coordinated pieces stored in the storage section 23 of the piece exhibition server 20. The storage section 23 stores, for each coordinated piece, information of the user ID of the user who has created the coordinated piece, the coordinate number, the coordinated top item, the coordinated bottom item, the number of ratings, and the number of purchases. Also at this time, the IDs of the items are stored for the top item and the bottom item.

When the rating instruction information is received from the game terminal 10, the processing section 22 increments the number of ratings for the corresponding coordinated piece. Also, when the purchasing instruction information is received from the game terminal 10, the processing section 22 increments the number of purchases of the corresponding coordinated piece.

Also, every time the piece exhibition server 20 communicates with the game terminal 10 in the full version, the piece exhibition server 20 transmits (feeds back), to the game terminal 10, latest information about the number of ratings and the number of purchases for the coordinated piece of the game terminal 10. At the game terminal 10, when the information about the number of ratings and the number of purchases for the coordinated piece of the game terminal 10 is received from the piece exhibition server 20 by the communication section 15, the processing section 13 updates the number of ratings and the number of purchases in the data (see FIGS. 5A to 5C) of the coordinated piece stored in the storage section 14. Additionally, “−” for the number of ratings and the number of purchases for a coordinate number 2 in the game terminal 10B in FIG. 5B means that the coordinated piece is locally created at the game terminal 10B, but the piece is not uploaded to the piece exhibition server 20.

### Transition from Limited Version to Full Version

When a user causes the limited version to transition (to be upgraded) to the full version, data generated in the limited version, that is, data of purchased items and data of created coordinated pieces, are carried over the full version. That is, when the user plays with the limited version, and then, the limited version is transitioned to the full version, the full version is not started from initial conditions, and the items purchased in the limited version or the coordinated pieces created in the limited version are carried over to the full version.

For this purpose, the game terminal 10 in the limited version stores each piece of information about an item possessed by the user, a coordinated piece which has been created, and the remaining amount of virtual money in the storage section 14 embedded in the game terminal 10. When the game program for the full version is first started, whether or not data of the limited version is stored in the storage section 14 embedded in the game terminal 10 is determined, and in the case where the data of the limited version is present, the data is reflected in the data of the full version. In the case where the game program for the full version is to be read out from a portable memory to be executed, and generated data is to be stored in the portable memory, the data of the limited version stored in the storage section 14 embedded in the game terminal 10 is copied to the portable memory. This function of the full version game terminal 10 is referred to also as a data inheritance section.

As described above, according to the game system 100 of the present embodiment, a limited version user for whom upload of a coordinated piece is limited may also access the piece exhibition server 20, and view coordinated pieces of users actually enjoying the full version game, in the same manner as a full version user. Accordingly, a limited version user may easily imagine the enjoyment he/she can experience when he/she has become a full version user. Transition from the limited version to the full version may thus be encouraged.

Also, according to the game system 100 of the present embodiment, a limited version user may also view all the coordinated pieces exhibited by the piece exhibition server 20, and view all the items that are on sale at the shop server 30, and thus, the limited version user may realize the wide range of items prepared by the game system 100, and transition from the limited version to the full version may thus be encouraged.

Furthermore, according to the game system 100 of the present embodiment, a limited version user may view the degree of reaction from other users (the number of ratings, and the number of purchases) for a coordinated piece that is exhibited by the piece exhibition server 20, and the limited version user is motivated to become a full version user and to receive reactions from other users for his/her coordinated piece, and transition from the limited version to the full version may thus be encouraged.

Furthermore, according to the game system 100 of the present embodiment, items one has selected and acquired in the limited version may be carried over to the full version at the time of transitioning from the limited version to the full version, and a limited version user who has vigorously played the limited version is not negatively affected by the transition, that is, there is no data loss due to the transition, and thus, transition from the limited version to the full version may be encouraged.

Furthermore, the game system 100 of the present embodiment not only encourages transition from the limited version to the full version in the manner described above, but it is also beneficial to the full version user. A full version user is motivated to play the coordinating game by exhibiting, at the piece exhibition server 20, a coordinated piece that he/she has created and receiving reactions (ratings, purchases) from other users, and with the game system 100 of the present embodiment, since not only the full version users, but also the limited version users are allowed to perform an action (rating, purchasing) for a coordinated piece exhibited at the piece exhibition server 20, the full version user may receive reactions (ratings, purchases) from a greater number of users for a coordinated piece that the full version user has created and uploaded. That is, according to the game system 100 of the present embodiment, the number of users to access the piece exhibition server 20 may be increased, and the shopping mall as a virtual space provided by the piece exhibition server 20 may thereby be vitalized, and thus, the satisfaction of the full version users may be increased.

Additionally, according to the game system 100 of the embodiment described above, the shop server 30 is provided, and at the time of purchasing an item by the game terminal 10, the shop server 30 is accessed by the game terminal 10, a shop screen including the item is downloaded from the shop server 30, and a purchasing process for the item that is to be purchased is performed, but the game system 100 does not necessarily have to include the shop server 30. In this case, the shop screen and information about all the items are stored in each game terminal 10, and the game terminal 10 performs the purchasing process for an item using the shop screen and the information.

Moreover, at the time of the provider of the game system 100 adding a new item, if items are to be purchased by accessing the shop server 30 as in the embodiment described above, the provider adds the new item to the shop server 30, and if the purchasing process for items is to be performed by only the game terminal 10, data of the new item is delivered to each game terminal 100 by the provider of the game system 100.

Furthermore, with the game system 100 of the embodiment described above, the game program is executed by each game terminal 10, and data of possessed items and data of coordinated pieces are stored in each game terminal 10, but the mode of the game system is not limited to such. A game server for executing the game program may be provided for the game system 100, and the game server may perform the game processing. At this time, the game terminal 10 connects to the game server over a network, displays a display screen transmitted from the game server on the display section 11, and transmits operation information of a user input to the input section 12 to the game server. Moreover, such a game server and the piece exhibition server 20 described above may be the same server. Furthermore, processes of the game terminal 10 may be performed by a plurality of devices (for example, a mobile device and a stationary device) in a decentralized manner.

Furthermore, according to the game system 100 of the embodiment described above, data of a possessed item of a user is stored in the storage section 14 of the game terminal 10, but the data of a possessed item of a user may be stored, in association with a user ID, on a data server capable of communication with the game terminal 10. In this case, at the time of playing the game, a user accesses the data server, and may download the data of his/her possessed item using the user ID.

Furthermore, in the embodiment described above, the coordinating game of creating a coordinated piece by combining pieces of clothing which are the items is described as an example of the data acquisition game, but the data acquisition game is not limited to such. The data acquisition game may be a game of creating a piece without using items. Or, in the case where the data acquisition game is a game of using an item, a piece may be created not by combining items, but by using an item as a tool.

Also, in the case where the data acquisition game is a game of creating a piece by combining items, a three-dimensional piece may be created by combining parts such as blocks, for example, instead of creating a piece by coordinating clothes and accessories. Also, the data acquisition game that uses items may allow a change to be made in the items. Also, information processing to be performed at each terminal of the information processing system of the technology is not limited to games, and the pieces to be obtained are not limited to pieces created by combining items. A piece to be created may be a picture drawn by a user using painting software, or a piece of music played by the user using instrument software, for example.

Furthermore, it is enough if the information processing to be performed at each terminal of the information processing system is information processing for obtaining predetermined data according to an operation of a user, and it is not limited to the data acquisition game of creating a piece based on an instruction from a user. That is, an object to be uploaded from the game terminal to the exhibition server to be exhibited at the exhibition server is not limited to a piece created by a user. Data other than a piece created by a user includes data that, if it is exhibited and published to others, would motivate the user who has published it; for example, UGC, products or the like such as a rare item which may be obtained by playing the game, detailed scores of a sports game, a reproduced video or the like of a fighting game or a sports game, and the like.

Furthermore, according to the embodiment described above, some functions of the first program are limited for the second program, but the relationship between the first program and the second program is not limited to such a relationship. For example, the functions of the first program and the second program may be different, such as in a case where the first program is a program that provides a game where a user acting as a shop owner uploads a piece, and where the second program is a program that provides a game where a user acting as a customer downloads a piece.

While the technology has been described in detail, the foregoing description is in all aspects illustrative and not restrictive. It will be understood that numerous other modifications and variations can be devised.

What is claimed is:

1. An information processing system including an information processing apparatus for performing information processing according to a first program, and an information processing apparatus for performing information processing according to a second program different from the first program,
wherein the information processing apparatus for performing information processing according to the first program includes
a first acquisition section for obtaining predetermined data according to an operation of a user,
an upload section for uploading the data acquired by the first acquisition section, and
a first viewing section for viewing the data uploaded by another information processing apparatus for performing information processing according to the first program, and
wherein the information processing apparatus for performing information processing according to the second program includes
a second acquisition section for obtaining predetermined data according to an operation of a user, and
a second viewing section for viewing the data uploaded by the information processing apparatus for performing information processing according to the first program, and
wherein the information processing apparatus for performing information processing according to the second program does not include a section for uploading the data acquired by the second acquisition section.

2. The information processing system according to claim 1, wherein the first program and the second program are different in their functions.

3. The information processing system according to claim 1, wherein functions of the first program are partially limited for the second program.

4. The information processing system according to claim 1, wherein the first acquisition section and the second acquisition section each create a piece as the data, according to an instruction from a user.

5. The information processing system according to claim 4, wherein the first acquisition section and the second acquisition section each create the piece using a possessed item.

6. The information processing system according to claim 5, wherein the first acquisition section and the second acquisition section each create, as the piece, a piece by combining a plurality of items.

7. The information processing system according to claim 5, wherein the item is allowed to be possessed by purchasing using virtual money.

8. The information processing system according to claim 1, wherein, in a case where an information processing apparatus that was performing information processing according to the second program is to perform information processing according to the first program, the data that was possessed when information processing was being performed according to the second program is inherited as possessed data when performing information processing according to the first program.

9. The information processing system according to claim 1, wherein the second program is executed by the information processing apparatus as a trial version game for encouraging transition to the first program.

10. The information processing system according to claim 4,
wherein the information processing apparatus for performing information processing according to the first program and the information processing apparatus for performing information processing according to the second program each further include an action section for performing an action with respect to a desired piece whose data has been uploaded, and
wherein the action is fed back to an uploader of the piece.

11. The information processing system according to claim 10,
wherein the action is rating of the piece whose data has been uploaded, and
wherein the rating is fed back to the uploader of the piece.

12. The information processing system according to claim 10,
wherein the action is downloading of the piece whose data has been uploaded, and
wherein the downloading is fed back to the uploader of the piece.

13. The information processing system according to claim 10,
wherein the piece is allowed to be purchased using virtual money, and
wherein, when the piece is purchased, a remaining amount of the virtual money of a user who has uploaded the piece is increased.

14. The information processing system according to claim 4,
wherein the upload section uploads data of the piece to a server, and
wherein the first viewing section and the second viewing section each view the piece uploaded to the server.

15. The information processing system according to claim 14, wherein the data of the piece is exhibited in a virtual space provided by the server, by being uploaded to the server.

16. A computer-readable storage medium having stored therein a second program causing a computer of an information processing apparatus to function as:
a second acquisition section for obtaining predetermined data according to an operation of a user; and
a second viewing section for viewing the data uploaded by an information processing apparatus for performing information processing according to a first program different from the second program,
wherein the second program does not cause the computer to function as a section for uploading the data obtained by the second acquisition section.

17. A computer-readable storage medium having stored therein a first program causing a computer of an information processing apparatus to function as:
a first acquisition section for acquiring predetermined data according to an operation of a user;
an upload section for uploading the data acquired by the first acquisition section;
a first viewing section for viewing data uploaded by another information processing apparatus; and
a data inheritance section for inheriting, as data to be possessed when performing information processing according to the first program, data possessed when information processing was being performed according to a second program that causes a computer to function as a second acquisition section for acquiring predetermined data but not as a section for uploading the acquired data.

18. A server for configuring an information processing system by being connected, in a manner capable of communication, to an information processing apparatus for performing information processing according to a first program and an information processing apparatus for performing information processing according to a second program different from the first program, the server comprising:
a viewing screen generation section for generating a viewing screen for allowing viewing of data uploaded by the information processing apparatus for performing information processing according to the first program; and
a transmission section for transmitting the viewing screen in response a viewing request from the information processing apparatus for performing information processing according to the first program or from the information processing apparatus for performing information processing according to the second program,
wherein the viewing screen does not include data acquired by the information processing apparatus for performing information processing according to the second program.

19. An information processing apparatus for performing information processing according to a second program, the information processing apparatus comprising:
a second acquisition section for obtaining predetermined data according to an operation of a user; and
a second viewing section for viewing the data uploaded by an information processing apparatus for performing information processing according to a first program different from the second program,
wherein the information processing apparatus for performing information processing according to the second program does not include a section for uploading the data acquired by the second acquisition section.

20. An information processing method comprising:
acquiring predetermined data according to an operation of a user, by an information processing apparatus for performing information processing according to a first program;
uploading the acquired data by the information processing apparatus for performing information processing according to the first program;
viewing, by the information processing apparatus for performing information processing according to the first program, the data uploaded by another information processing apparatus for performing information processing according to the first program;
acquiring predetermined data according to an operation of a user, by an information processing apparatus for performing information processing according to a second program different from the first program; and
viewing, by the information processing apparatus for performing information processing according to the second program, the data uploaded by the information processing apparatus for performing information processing according to the first program,
wherein the information processing apparatus for performing information processing according to the second program does not upload the data.
